(19) United States
(12) Patent Application Publication
(10) Pub. No.: US 2025/0196792 A1
(43) Pub. Date: Jun. 19, 2025

(54) BUMPER HAVING REINFORCEMENT PLATE AND IMPROVED CRASH PROPERTY

(71) Applicant: BENTELER AUTOMOBILTECHNIK GMBH, Paderborn (DE)

(72) Inventor: Andreas SCHILLER, Geseke (DE)

(21) Appl. No.: 18/977,939

(22) Filed: Dec. 12, 2024

(30) Foreign Application Priority Data
Dec. 15, 2023 (EP) 23217157.9

(51) Int. Cl. B60R 19/18

(52) U.S. Cl. CPC B60R 19/18; B60R 2019/1806

(57) ABSTRACT

The present invention relates to a bumper crossbeam for a motor vehicle, which extends in the motor vehicle transverse direction and has a hollow profile in cross section, in particular a rectangular cross section, wherein a reinforcement plate is inserted in a central longitudinal section. The reinforcement plate is coupled on one side in the motor vehicle longitudinal direction to a front wall or rear wall of the hollow profile and has a distance in the motor vehicle longitudinal direction to the remaining front side or rear side and the front side or rear side in the area of the coupled point has a formation oriented in the longitudinal direction of the motor vehicle which corresponds to at least 80% of the length of the distance.

The invention relates to a bumper crossbeam according to the features in the preamble of claim 1.

Bumper crossbeams which are coupled to the front or end of motor vehicle bodies are known from the prior art. This is usually done with crash boxes incorporated. Such a bumper crossbeam is usually produced from a metallic material, in particular a steel material or light metal material and can also be referred to as a bumper or crossbeam.

A bumper crossbeam is to have sufficient rigidity so that a sufficient supporting effect is achieved in particular, for example, during a pole test or post test. The bumper crossbeam itself is designed to be as rigid as possible. The motor vehicle impacts on an object and the crash boxes deform, due to which crash energy is converted into deformation work.

However, there are also bumper crossbeams that are supposed to deform to a certain extent without losing any residual rigidity. In particular, the bumper crossbeam is not supposed to buckle or collapse when a force level is exceeded, for example in a pole test or post test.

For this purpose, a bumper crossbeam is known from WO 20 2005 3626 A1, for example, which has a reinforcement plate in a middle longitudinal section. The reinforcement plate helps to stiffen the bumper crossbeam in the middle area.

In electric motor vehicles, the bumper crossbeam has to be designed to be more rigid than in motor vehicles with combustion engines, in particular to protect the batteries or accumulators located behind it. This applies in particular to a pole test or post test, so that intrusion of the bumper crossbeam between the front wheels or the front vehicle area of the motor vehicle can be effectively avoided.

A generic crossbeam is known from EP 4 177 114 A1.

The object of the present invention is to further optimize the bumper crossbeam with regard to its crash properties, in particular to avoid intrusion during a pole test or post test.

The object is achieved according to the invention by the features in claim 1.

Advantageous embodiment variants are described in the dependent claims.

The bumper crossbeam according to the invention is suitable for a motor vehicle, in particular an electric motor vehicle. The bumper crossbeam extends in the vehicle transverse direction and is coupled to a motor vehicle in particular via crash boxes in the front vehicle area. A bumper crossbeam arrangement can therefore also be referred to as a bumper crossbeam arrangement. The bumper crossbeam itself has a hollow profile in cross section, which in particular has a rectangular cross section. A reinforcement plate is inserted in a middle longitudinal section.

According to the invention, the reinforcement plate is now coupled, in particular joined, to the hollow profile on one side, as seen in the motor vehicle longitudinal direction, either on a front wall on the inside. The reinforcement plate then has a distance to the remaining rear side, also measured in the motor vehicle longitudinal direction. For example, if the reinforcement plate is coupled to the inside of the front wall in the bumper crossbeam, a rear side of the reinforcement plate has a distance from the rear wall. The front side or front wall has, at least in the longitudinal section of the reinforcement plate, a formation oriented outwards in the motor vehicle longitudinal direction. Outward relates to the interior of the bumper crossbeam. This formation is formed in the area of the coupled point or the coupled section to the longitudinal section having the reinforcement plate. The formation thus extends in the motor vehicle longitudinal direction over at least 80% of the distance, preferably more than 85%, in particular more than 90%, particularly preferably more than 95%. However, the formation is less than 120%, particularly preferably less than 110%, in particular less than 105%. For this purpose, the distance has a length in the motor vehicle longitudinal direction over which the distance extends, i.e. the rear side of the reinforcement plate to the inner side of the rear wall of the hollow profile. The percentage specification then relates to the length of this distance. Very particularly preferably, the length of the formation in the motor vehicle longitudinal direction essentially corresponds to the distance.

The distance is preferably 1 to 6 mm, particularly preferably 5 mm. However, the distance is in particular to be at least 2 to 3 mm.

Surprisingly, the following inventive effect has emerged in this way. Because the formation in the area of the coupled point is essentially shaped outwards with respect to an inner side of the bumper crossbeam, the reinforcement plate is therefore arranged relatively offset within the bumper crossbeam. In a crash scenario, the area of the formation initially shifts relatively due to self-deformation in the area of the bumper crossbeam, such that the distance between the reinforcement plate and preferably the inner side of the rear wall decreases to zero. The reinforcement plate therefore comes into contact on the inner side of the rear wall of the bumper crossbeam. The front wall is preferably only deformed in a small area of the formation, but otherwise the front wall is not yet deformed and thus the bumper crossbeam is also not deformed. If the object to be impacted penetrates further, the reinforcement plate bears within the bumper crossbeam and upon further deformation, the reinforcement plate then has to be further deformed together with the bumper crossbeam.

Both components, the reinforcement plate and the bumper crossbeam, are still undeformed at this point in time in the crash sequence. This is where the invention surprisingly comes into play, as a result of which a higher local bending resistance is achieved, due to which in particular the crash performance of the bumper crossbeam according to the invention is effectively increased without, for example, the need for increased use of material. However, the gap is present as a result of production due to tolerance reasons.

A further effect is that, in particular when the geometric formation is created by two beads formed along the length course, this also additionally stiffens or reinforces the crossbeam.

The hollow profile of the crossbeam is formed in particular by a hat profile having a strike plate. The strike plate is particularly preferably arranged oriented facing forward in the motor vehicle longitudinal direction. The available impact surface is thus increased due to the outwardly-projecting flanges of the hat profile in conjunction with the strike plate.

The reinforcement plate itself has a profiled cross section, in particular U-shaped or V-shaped or also W-shaped or omega-shaped.

Particularly preferably, the bumper crossbeam itself is made of a steel material, in particular the strike plate is also made of a steel material, in particular, for example, hot-formed press-hardened bars can be used, particularly preferably at least local areas can be provided with a tensile strength greater than 1300 MPa.

The wall thickness can be 1 to 3 mm for the crossbeam, in particular the hat profile, preferably 2 mm. The strike plate is particularly preferably produced in a wall thickness of 1 to 1.5 mm, particularly preferably 1 to 2 mm. For example, it is conceivable that the hat profile has a higher tensile strength Rm than the strike plate. For example, the hat profile can be produced from high-strength or ultra-high-strength steel or hot-formed steel, whereas the strike plate can be produced from normal steel or high-strength steel or ultra-high-strength steel.

The reinforcement plate is thermally joined, in particular welded, to the strike plate, in particular on the inside. The strike plate itself is then in turn preferably thermally joined, in particular welded, to the flanges of the hat profile.

The reinforcement plate is seated centrally in relation to the motor vehicle transverse direction. In particular, it extends over 10 to 50%, preferably 20 to 40% of the length of the bumper crossbeam. However, the reinforcement plate can also extend over a larger part in the motor vehicle transverse direction. Particularly preferably, it then extends at least partially overlapping the crash boxes, with respect to the motor vehicle transverse direction.

This results in significantly higher stiffening of the entire crossbeam.

The reinforcement plate itself can be designed to be narrower or tapered at its ends (the ends are in the motor vehicle transverse direction) with respect to the motor vehicle longitudinal direction. This can be produced, for example, by a cutting process of the reinforcement plate.

Instead of two curved beads, the strike plate can also have a bulge. This bulge or geometric formation corresponds, in relation to the front wall itself, essentially to the distance which the reinforcement plate has to the inner side of the rear wall of the bumper crossbeam.

Further advantages, features, and properties of the present invention are the subject matter of the following description. Preferred embodiment variants are shown in the schematic figures. These simplify the understanding of the invention.

In the figures:

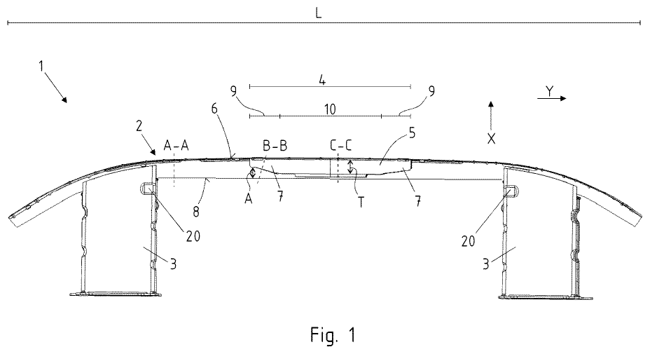

FIG. 1 shows a bumper crossbeam arrangement according to the invention in a top view,

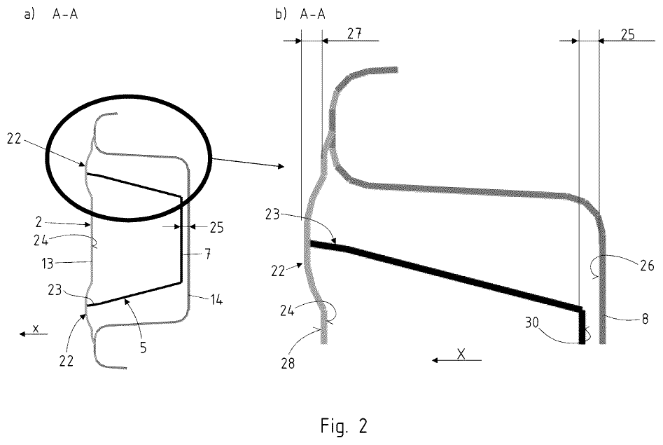

FIGS. 2a and b show a cross-sectional view along section line A-A of FIG. 1,

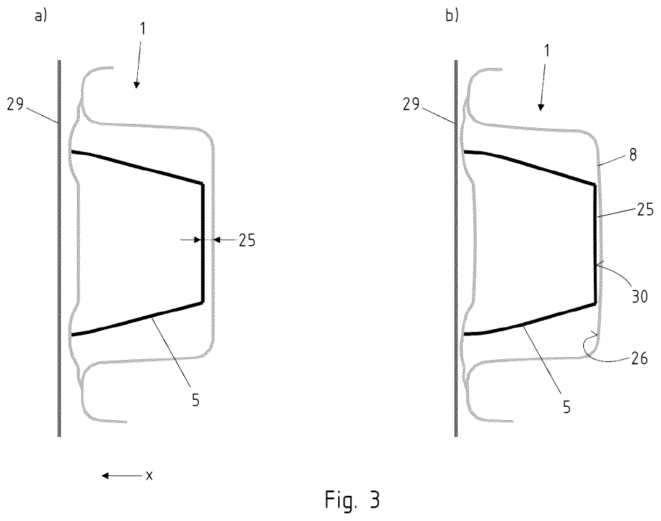

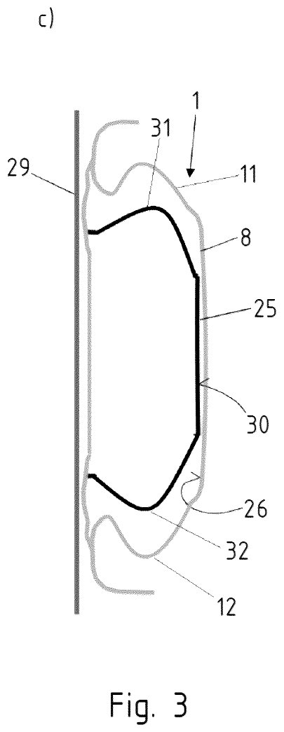

FIGS. 3a, b, and c show a cross-sectional view along line A-A before and after the immediate occurrence of a crash scenario,

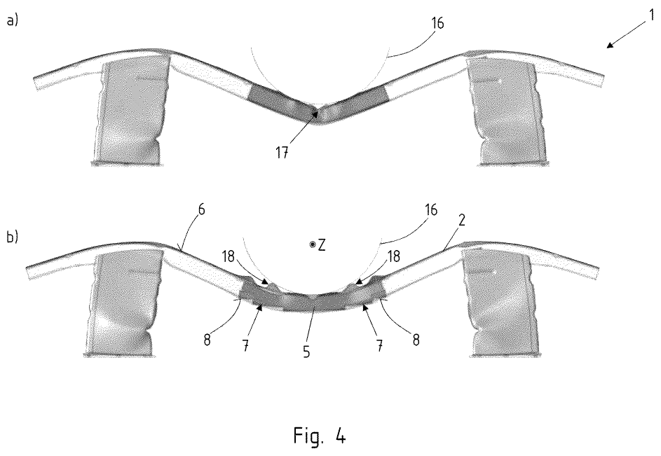

FIGS. 4a and b show the bumper arrangement in a top view in a crash scenario,

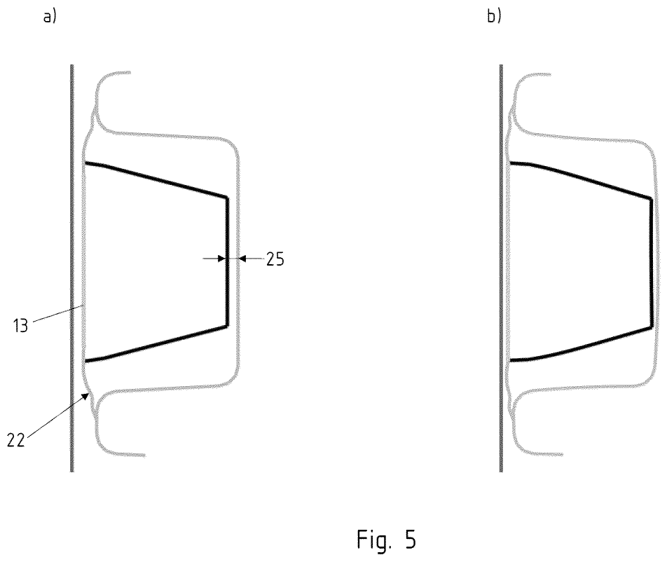

FIGS. 5a and b show an alternative design variant to FIGS. 2a and b, and

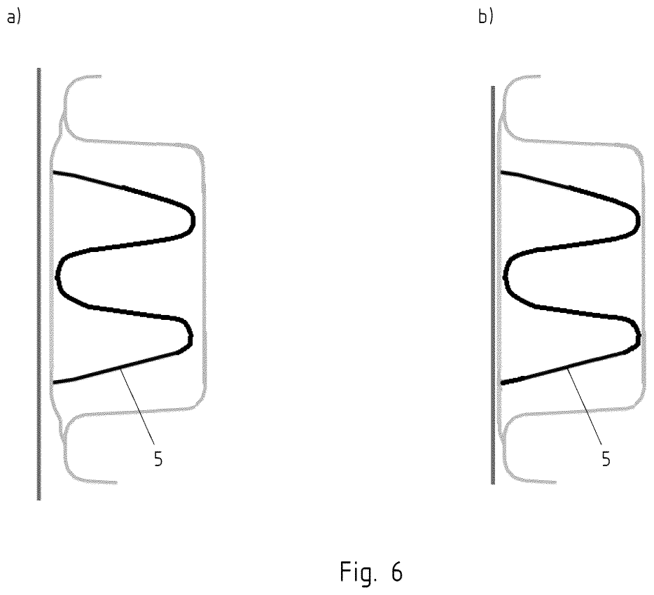

FIGS. 6a and b show an alternative design variant to FIGS. 5a and b.

In the figures, the same reference numbers are used for same or similar components, even if a repeated description is omitted for reasons of simplicity.

FIG. 1 shows a bumper crossbeam arrangement 1 in a top view. The bumper crossbeam 2 is coupled to crash boxes 3. The bumper crossbeam arrangement 1 is then coupled to a motor vehicle body (not shown in more detail). The bumper crossbeam 2 has a substantially curved profile over its length. A middle longitudinal section 4 can also be essentially straight.

In a middle longitudinal section 4, a separate reinforcement plate 5 shown here is arranged in the bumper crossbeam 2 and coupled to a strike plate 13. The strike plate 13 with the reinforcement plate 5 is in turn coupled to the front wall or flanges of the bumper crossbeam 2. The reinforcement plate 5, the strike plate 13, and the bumper crossbeam 2 or the hollow profile of the bumper crossbeam 2 are therefore three separate components. At the respective ends 7 of the reinforcement plate 5, the reinforcement plate 5 is tapered in its depth T. The depth T is essentially oriented in the motor vehicle longitudinal direction X. The middle longitudinal section 4 has a longitudinal extension of approximately 20% to 50%, in particular 20% to 40% of the length L of the bumper crossbeam 2. The length L relates to the motor vehicle transverse direction Y.

The reinforcement plate 5 has tapered ends 7 and the distance A between a rear wall 8 of the bumper crossbeam 2 and the respective tapered end 7 is increased due to the tapered ends 7. Over the entire longitudinal course, the reinforcement plate 5 has no direct contact with the rear wall 8 of the bumper crossbeam 2.

Furthermore, a respective longitudinal section is designed as a welded longitudinal section 9, in which the reinforcement plate is welded to the strike plate 6. The welded longitudinal sections 9 particularly preferably make up 5% to 20%, in particular 5% to 10% of the middle longitudinal section 4. An interposed non-welded longitudinal section 10 can thus deform in case of a crash or the front wall 6 and the reinforcement plate could move relative to one another. The entire longitudinal section 4 between the front wall and the reinforcement plate can also be welded.

Furthermore, relief elements 20 can particularly preferably be arranged on the mutually facing side walls of the crash box 3. The relief elements 20 can be designed, for example, as a slot, an elongated hole, a round hole, or even an embossing. A deliberate weakening of the crash boxes 3 takes place here. In the crash case shown in FIG. 4, the crash boxes 3 can thus move towards one another and therefore also promote a deflection of the bumper crossbeam 2, in particular according to FIG. 4b.

FIGS. 2a and 2b show a section line in cross section A-A at Y=0 from FIG. 1. It can be seen that the bumper crossbeam 2 is designed in cross section as a hat profile 14, wherein this has a hat profile 14 and a front strike plate arranged at the front in the motor vehicle X direction. Two bulges 22 in the form of beads are formed in the strike plate 13. These bulges 18 protrude forward relative to the strike plate 13 oriented in the motor vehicle longitudinal direction X of the. The reinforcement plate 5 is coupled to the striking plate 13 within the bulge 22. Here, the ends of webs are coupled to the inner side of the strike plate 13, thus the front wall 6. In the detailed enlargement according to FIG. 2b, a distance thus results from the inner side of the rear wall to a rear side of the reinforcement plate 5 directed toward the motor vehicle longitudinal direction X. This distance 25 essentially corresponds to the length or the dimension 27 by which the bulge protrudes relative to the front side of the strike plate 13.

This results in the effect according to the invention shown in FIGS. 3a and 3b. The bumper arrangement therefore strikes a colliding object in the motor vehicle X-direction. FIG. 3a shows a situation shortly before impact. FIG. 3b then shows a condition that occurs shortly after the initial impact of the object on the bumper arrangement. The distance 25 is reduced to zero. The rear side of the reinforcement plate 5 bears on the inner side of the rear wall.

However, in this state, which is shown in FIG. 3b, a few milliseconds after the first impact, the bumper crossbeam itself and the reinforcement plate are not yet further deformed.

The effect according to the invention is now shown in comparison in FIGS. 4a and b. The bumper arranged 2 is pressed in or undergoes a bend or curved deformation due to a pole or pillar 16. According to FIG. 4a, a kink 17 or even a crack in the middle of the rear wall occurs, which results in the immediate complete collapse of the bumper without further energy dissipation. In this case, either no reinforcement plate is used or a reinforcement plate 5 without tapered ends and without coupling into a bulge of the strike plate.

According to FIG. 4b, the rear wall of the bumper crossbeam 8 preferably nestles further against the tapered ends 7 of the reinforcement plate 5 according to the invention, while—as can be clearly seen in FIG. 3c—both the upper flange 11 and lower flange 12 of the crossbeam as well as the horizontal walls 31, 32 of the reinforcement plate 5 are deformed simultaneously and in the same way. This prevents buckling and dissipates a large amount of impact energy. The front wall 6 and also the rear wall 8 can each move relative to the reinforcement plate 5 in the motor vehicle transverse direction. On the rear wall 8 this takes place according to the principle of a tension band. Slight bulges 18 result on the front wall 6, but there is no kinking or buckling. In this way, according to the invention, a targeted deformation is provided for energy dissipation without the bumper crossbeam 2 breaking through.

The actual deformation, as now shown in FIG. 4a and FIG. 4b, then takes place only after the condition of FIG. 3b. However, during the condition of FIG. 3b, the section modulus against bending is particularly high. However, the distance 25 of the rear side of the reinforcement plate to the inner side of the rear wall shown in FIG. 3a or FIGS. 2a and b is initially required for tolerance reasons in the manufacturing of the bumper crossbeam with strike plate 13. However, by deliberately utilizing or standardizing the distance of the rear wall of the reinforcement plate to the inner side of the rear wall of the hollow profile in conjunction with the protruding bulge, this can have an advantageous effect on the crash properties.

FIG. 5a and FIG. 5b show an exemplary embodiment analogous to FIG. 3a and b.

Here, however, the formation or bulge formed in front is not formed as two beads, but as a surface of the strike plate 13 formed with an offset. The effect according to the invention occurs similarly here. FIG. 5b shows a condition immediately after the impact. The distance 25 is also formed to zero here and then the deformation of the reinforcement plate and bumper crossbeam 2 begins similarly.

FIG. 6a and FIG. 6b show an exemplary embodiment analogous to FIGS. 5a and b.

However, in this case the reinforcement plate itself is W-shaped in cross section. In FIGS. 2a and b, 3a and b, and 5a and b, the reinforcement plate 13 itself is U-shaped or V-shaped in cross section.

### REFERENCE SIGNS

1—bumper crossbeam arrangement
2—bumper crossbeam
3—crash box
4—middle longitudinal section
5—reinforcement plate
6—front wall of 2
7—end of 5
8—rear wall of 2
9—welded longitudinal section
10—non-welded longitudinal section
11—upper flange
12—lower flange
13—strike plate
14—hat profile
15—further longitudinal section
16—pole/pillar
17—kink
18—bulge
19—weld
20—relief element
21—rear wall of 5
22—bulge/formation
23—end
24—inner side of 6
25—distance
26—inner side of 8
27—length
28—front side of 6 or 13
29—object/barrier
30—rear side of 5
31—wall
32—wall
A—distance
T—depth
T7—depth of 7
T15—depth of 15
L—length of 2
X—motor vehicle longitudinal direction
Y—motor vehicle transverse direction

1-7. (canceled)

8. A bumper crossbeam for a motor vehicle, which extends in the motor vehicle transverse direction and has a hollow profile in cross section, in particular a cross section that is closed at least in longitudinal sections, wherein a reinforcement plate is inserted into a central longitudinal section, characterized in that the reinforcement plate is coupled on one side in the longitudinal direction of the motor vehicle to a front wall of the hollow profile and has a distance oriented in the longitudinal direction of the motor vehicle to a rear wall of the hollow profile and the front wall in the region of the coupled point has a formation oriented in the longitudinal direction of the motor vehicle, which corresponds to at least 80% and less than 120% of the distance.

9. The bumper crossbeam according to claim 8, wherein the hollow profile is designed as a hat profile with a strike plate.

10. The bumper crossbeam according to claim 8, wherein the strike plate is designed as a front wall of the hollow profile and is arranged pointing forward in the motor vehicle longitudinal direction.

11. The bumper crossbeam according to claim 8, wherein the reinforcement plate is profiled in cross section, in particular is U-shaped or V-shaped or is W-shaped.

12. The bumper crossbeam according to claim 8, wherein the reinforcement plate extends in the transverse direction of the motor vehicle over a length between 10 and 50%, preferably between 20 and 40% of the length of the bumper crossbeam.

13. The bumper crossbeam according to claim 8, wherein the reinforcement plate is coupled, in particular welded, to the front wall in longitudinal sections.

14. The bumper crossbeam according to claim 8, wherein the coupled wall has two outwardly curved beads oriented in the motor vehicle longitudinal direction, which extend in the motor vehicle transverse direction at least in the area of the reinforcement plate, preferably over at least 70%, preferably more than 80%, particularly preferably in the motor vehicle transverse direction of the length of the hollow profile, in particular extend overlapping the crash boxes at least in some sections.
